(19) United States
(12) Patent Application Publication
(10) Pub. No.: US 2007/0129210 A1
(43) Pub. Date: Jun. 7, 2007

(54) Vehicle control system and method

(75) Inventors: Kiyoshi Kimura, Obu-city (JP); Taku Itoh, Chita-gun (JP); Shigeru Yoshiyama, Kariya-city (JP)

Correspondence Address: NIXON & VANDERHYE, PC, 901 NORTH GLEBE ROAD, 11TH FLOOR, ARLINGTON, VA, 22203, US

(73) Assignee: DENSO CORPORATION, Kariya-city (JP)

(21) Appl. No.: 11/491,963

(22) Filed: Jul. 25, 2006

(30) Foreign Application Priority Data
Dec. 2, 2005 (JP) 2005-349382

(51) Int. Cl. F16H 59/60

(52) U.S. Cl. 477/97

(57) ABSTRACT

A vehicle control system for a vehicle includes a backup device which enables manual control of an automatic transmission apparatus, when a shift-by-wire device cannot electronically control the transmission apparatus. The backup device is normally restricted from operating, but released from the restricted condition when the shift-by-wire device is inoperable and a vehicle user is an authorized person. The vehicle user is checked by an immobilizer device, which also restricts the vehicle operation by disabling engine operation and by locking a steering wheel when the vehicle user is determined to be an unauthorized person.

### CROSS REFERENCE TO RELATED APPLICATION

This application is based on and incorporates herein by reference Japanese patent application No. 2005-349382 filed on Dec. 2, 2005.

### Field of the Invention

The present invention relates to vehicle control system and method, which electronically control a transmission apparatus of a vehicle by a shift-by-wire device.

### BACKGROUND OF THE INVENTION

Recent vehicles have shift-by-wire devices, which electronically control actuators for controlling vehicle conditions based on vehicle users' commands. For instance, U.S. Pat. No. 6,857,981 (JP 2004-52928A) discloses a shift-by-wire device for controlling an automatic transmission apparatus of a vehicle. If power supply of a battery is reduced or a power supply wire of a vehicle is disconnected, the shift-by-wire device becomes inoperative. As a result, the gear shift range of the automatic transmission apparatus cannot be switched. Therefore, a backup device is proposed as disclosed in JP 2003-28293A, JP 2003-34157A, JP2003-130209A and JP 2003-130210, so that the shift ranges of the automatic transmission apparatus may be manually changed without electric power supply from the battery.

The above shift-by wire device uses, as actuators for driving the transmission apparatus, a synchronous motor, a brush motor or the like. If the synchronous motor is used, an electronic control unit (ECU) exclusive to the synchronous motor is required.

It is recently required by regulations to provide a lock mechanism for a steering wheel or a transmission apparatus shift lever, so that the lock mechanism protects a vehicle from thefts. If the synchronous motor is used for the lock mechanism of the shift lever, the motor is restricted from being driven by shorting electric power supply wires, etc. As a result, no other anti-theft devices will be necessitated.

If the above backup device is added to the shift-by-wire device, the shift ranges can be changed without electric power supply from the battery. In this case, even if the synchronous motor is used in the shift-by-wire device, the shift lock function can be released or disabled. As a result, other steering lock mechanisms or shift lock mechanisms will be necessitated.

### SUMMARY OF THE INVENTION

The present invention is therefore directed to vehicle control system and method, which improve security of a shift-by-wire device for a transmission apparatus.

A control system and method is provided for a vehicle having an engine and a transmission apparatus for transmitting a driving force of the engine. The transmission apparatus is normally electronically controlled by a shift-by-wire device to change a gear shift range. During this normal control, a restriction device continues to restrict a backup device from being operated by a vehicle user to manually control the transmission apparatus. The manual operation of the transmission apparatus is enabled by the backup device, when the transmission apparatus is determined to be not operated properly by the shift-by-wire device. It is determined whether a vehicle user is an authorized person. The backup device is released from the restricted condition such that the manual operation of the transmission apparatus is enabled, when the vehicle user is determined to be the authorized person.

### BRIEF DESCRIPTION OF THE DRAWINGS

The above and other objects, features and advantages of the present invention will become more apparent from the following detailed description made with reference to the accompanying drawings. In the drawings:

FIG. 1 is a schematic diagram showing a vehicle control system according to a first embodiment of the present invention;

FIG. 2 is a flow chart showing control processing executed by a central control unit in the first embodiment;

FIG. 3 is a schematic diagram showing a vehicle control system according to a second embodiment of the present invention;

FIG. 4 is a flow chart showing control processing executed by a central control unit in the second embodiment; and

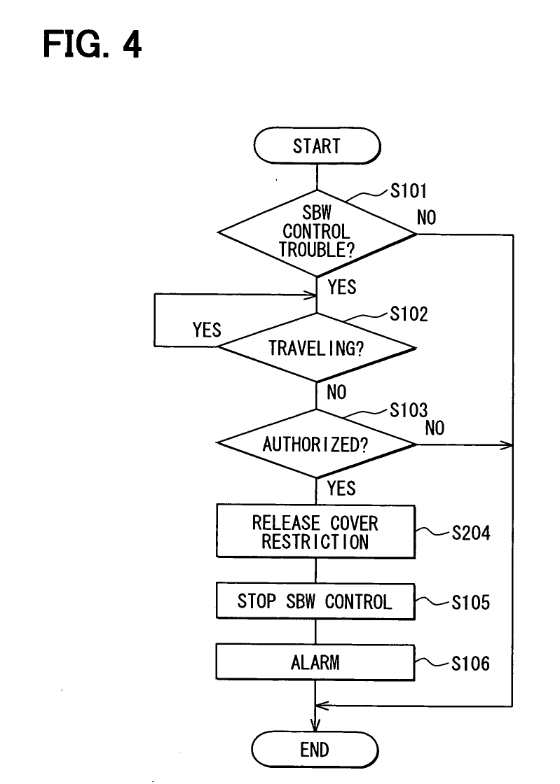

FIG. 5 is a schematic diagram showing a vehicle control system according to a third embodiment of the present invention.

### DETAILED DESCRIPTION OF THE EMBODIMENT

### First Embodiment

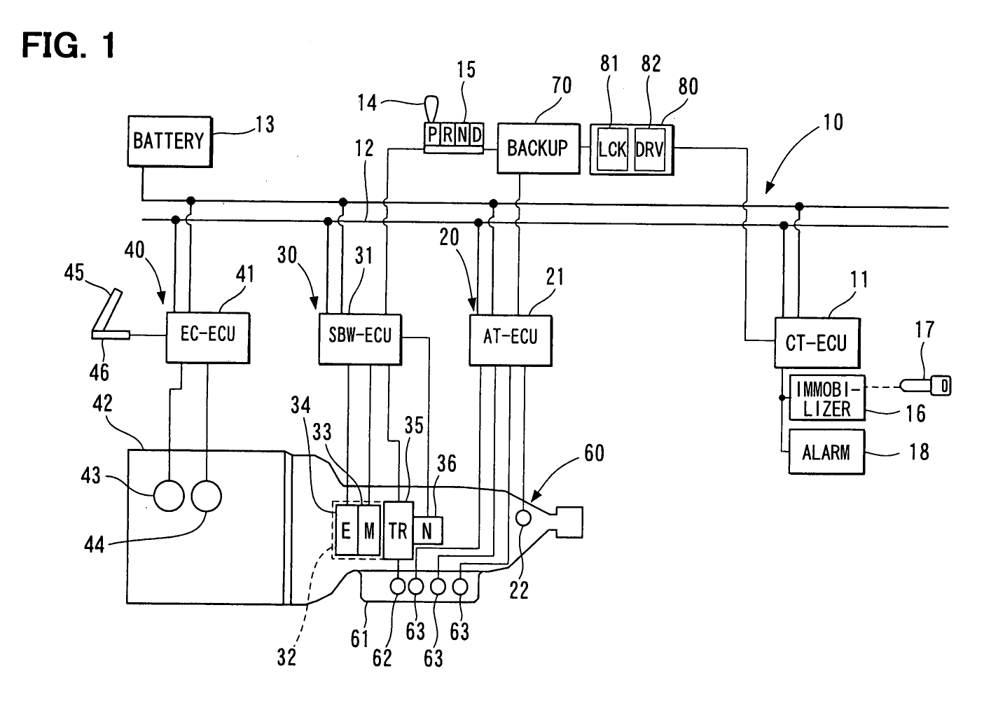

Referring first to FIG. 1, a vehicle control system 10 is mounted on a four-wheel vehicle (not shown), for instance, and has an automatic transmission apparatus control device 20, a shift-by-wire device 30 and an engine control device 40. The control system 10 also has a central control device, which is a central electronic control unit (CT-ECU) 1.

The control devices 20, 30 and 40 include an automatic transmission electronic control unit (AT-ECU) 21, a shift-by-wire electronic control unit (SBW-ECU) 31 and an engine electronic control unit (EC-ECU) 41, respectively. All the ECUs 11, 21, 31 and 41 are constructed with programmed microcomputers and associated circuits, respectively, and connected one another electronically or optically through an in-vehicle local area network (LAN) 12. Further the ECUs 11, 21, 31 and 41 are electrically connected to a vehicle power source, i.e., battery 13, to operate with electric power supplied from the battery 13. The CT-ECU 11 is provided to control the vehicle control system 10 jointly with the ECUs 21, 31 and 41, but in the centralized manner.

The automatic transmission apparatus control device 20 is for driving an automatic transmission apparatus 60 hydraulically, and includes a hydraulic circuit 61 for changing shift ranges and gear stages of the automatic transmission apparatus 60. The automatic transmission apparatus 60 has, as known well, a plurality of gear shift ranges, which are a drive range D, a reverse range R, a parking range P, a neutral range N and the like. The hydraulic circuit 61 has a manual valve 62, which selects shift ranges and changes hydraulic circuit arrangement. The automatic transmission apparatus 60 is set to one of the shift ranges by changing the hydraulic circuit arrangement by manual operation by the manual valve 62. The automatic transmission apparatus 60 has a plurality of friction engagement parts, which are coupled in different shift ranges or speed ranges. Each friction engagement part is engaged (coupled) or disengaged (released) by hydraulic fluid supplied by electromagnetic valves 63.

The AT-ECU 21 is electrically connected to electric components such as the electromagnetic valves 63 to control output pressures of fluid supplied by the electromagnetic valves 63. By this fluid pressure control, the friction engagement parts of the automatic transmission apparatus 60 are engaged or disengaged. The AT-ECU 21 is further connected to a speed sensor 22, which detects a vehicle speed based on a rotation speed of the output shaft of the automatic transmission apparatus 60, so that it controls the electromagnetic valves 63 in accordance with the vehicle speed.

The shift-by-wire (SBW) device 30 has an electromagnetic actuator 32, which drives the manual valve 62 of the automatic transmission apparatus 60. The actuator 32 includes a synchronous motor 33 and an encoder 34. The SWC-ECU 31 outputs a driving signal to the synchronous motor 33 so that the synchronous motor 33 rotates a shaft member (not shown) in response to the driving signal. The rotation of the synchronous motor 33 is reduced in a reduction device (not shown) and transmitted to a transmitting device 35, so that a driving force of the synchronous motor 33 is transmitted to the manual valve 62 after speed reduction.

A neutral switch 36 is provided to detect actual shift ranges in the automatic transmission apparatus 60 by detecting positions (P, R, N or D ranges) of the manual valve 62, and apply electric signals indicative of the detected positions of the manual valve 62 to the SBW-ECU 31.

The SBW-ECU 31 is electrically connected to a selector sensor 15 of a range selector 14 of the vehicle as well as to the synchronous motor 33 and the encoder 34. A vehicle user (driver) selects a desired gear shift range by the selector 14. The encoder may be a rotary encoder, which outputs pulse signals in correspondence to rotational angles of the synchronous motor 33. The SBW-ECU 31 detects the rotational angles of the synchronous motor 33 by counting the pulse signals. Thus, the shift range of the automatic transmission apparatus 60 changes with the rotational angle of the synchronous motor 33. The rotational angle of the synchronous motor 33 indirectly indicates the actual shift range, in which the automatic transmission apparatus 60 is operated.

The selector sensor 15 detects the shift range, command range, selected by the user by operating the range selector 14. The selector sensor 15 applies an electric signal indicative of the detected shift range to the SBW-ECU 31. The SBW-ECU 31 controls output signals to be applied to the synchronous motor 33 based on parameters or physical quantities indicated by detection signals of the encoder 34, the neutral switch 36 and the selector sensor 15.

The synchronous motor 33 is driven and controlled by the SBW-ECU 31 in the case the synchronous motor 33 is used as a driving power source of the actuator 32. That is, the rotational angle of the synchronous motor 33 is controlled by the SBW-ECU 31, which counts the pulse signals produced by the encoder 34. Therefore, even when the synchronous motor 33 is directly connected to the battery 13, for instance, the synchronous motor 33 cannot be driven unless a motor control signal is applied from the SBW-ECU 31. Thus, the security of the vehicle against vehicle theft is enhanced.

The EC-ECU 41 is electrically connected to a throttle 43 and injectors 44 of an engine 42, and to an accelerator sensor 46 of an accelerator 45. The throttle 43 is for regulating quantity of intake air supplied through an intake duct of the engine 42. The injectors 44 are for regulating quantity of fuel injected in each intake duct or cylinders. The accelerator sensor 46 detects the position of the accelerator 45 operated by the vehicle user and applies the detection signal to the EC-ECU 41. Thus, when the accelerator 45 is operated by the vehicle user, the throttle 43 and the injectors 44 are electrically controlled by the EC-ECU 41 based on the operation amount of the accelerator 45. As a result, the EC-ECU 41 regulates the output rotation and torque of the engine 42.

The vehicle control system 10 further includes an immobilizer device 16, which either enables or disables operation of the vehicle. The immobilizer device 16 is electrically connected to the CT-ECU 11. The immobilizer device 16 checks ID information of a mobile terminal device carried by the vehicle user. If the mobile terminal device is validated as an authorized one, the CT-ECU 11 permits the vehicle operation, for instance, enables starting of the engine 42. The mobile terminal device may be a key 17 carried by a vehicle user and provided in correspondence with each vehicle. The mobile terminal device is not limited to the electronic key 17, but may be other devices such as a card provided for each vehicle.

The CT-ECU 11 is also connected to an alarm device 18, which generates an alarm in response to an instruction from the CT-ECU 11. The alarms may be a visual alarm displayed in a predetermined form on a dashboard or a sound alarm generated by a horn or buzzer.

The vehicle control system 10 further includes a backup device 70. The automatic transmission apparatus 60 is normally controlled to change shift ranges by the SBW device 30. When the range selector 14 or the SBW device 30 fails to operate properly, the automatic transmission apparatus 60 cannot be controlled by the SBW device 30. For instance, the vehicle cannot be pulled, towed or moved, if the shift range of the automatic transmission apparatus 60 is in the parking range P. Therefore, when the shift range of the automatic transmission apparatus 60 cannot be changed from the parking range P to any other ranges due to failure in the range selector 14 or the SBW device 30, that is, driving range D, reverse range R or neutral range N, the vehicle cannot be moved to other places.

The backup device 70 is provided to release the automatic transmission apparatus 60 from being controlled by the SBW device 30 when the automatic transmission apparatus 60 is restricted from being controlled by the SBW device 30. The automatic transmission apparatus 60 is thus enabled to be controlled manually by the user in place of the SBW device 30.

The backup device 70 is constructed to enable the user to input a shift range, which he/she desires, into the AT-ECU 21, so that the AT-ECU 21 responsively changes the shift range into the shift range input from the backup device 70. The backup device 70 may be constructed to have a mechanical structure coupled to the manual valve 62. Thus, the automatic transmission apparatus 60 is forced to change the shift range based on the shift range directly input from the backup device 70. When the backup device 70 is released from operation restriction and operates to attain the backup operation, the CT-ECT 11 detects the backup operation of the backup device 70.

The vehicle control system 10 also includes a restriction device 80, which normally restricts or disables the operation of the backup device 70. The restriction device 80 may be constructed with a lock unit 81 and a driving unit 82 for driving the lock unit 81. The lock unit 81 may be constructed to mechanically restrict the operation of the backup device 70. With the backup device 70, the shift range of the automatic transmission apparatus 60 can be changed to any shift range as desired. The backup device 70 may, on the other hand, be used with wrongful intent such as theft, because the backup device 70 enables manual shifting of the shift range of the automatic transmission apparatus 60. For this reason, the restriction device 80 is provided to limit the backup device 70 to allow manual shifting operation only to time when the key 17 is the authorized one, that is, the user is the authorized person as carrying the key 17.

The CT-ECU 11 is provided to operate as a restriction control device, which controls the restriction device 80. The CT-ECU 11 drives the restriction device 80 so that the operation of the lock unit 81 is released by the driving unit 82, when the CT-ECU 11 determines that a user operating the backup device 70 is the authorized person by checking the authorization of the key 17 by the immobilizer device 16. Thus, the restriction device 80 is released from operation restriction on the backup device 70 so that the backup device 70 may be allowed to control the automatic transmission apparatus 60.

The driving unit 82 is driven with electric power supplied from the battery 13 as a motor or an electromagnetic solenoid is. When the electric power is supplied from the battery 13 in response to the command from the CT-ECU 11, the driving unit 82 releases the backup device 70 from being restricted by the lock unit 81. Therefore, when no electric power is supplied from the battery 13, the lock unit 81 continues to restrict the backup device 81 from attaining the backup operation. Thus, if the user operating the backup device 70 is not determined to be the authorized person, the CT-ECU 11 does not turn on the power supply. As a result, the driving unit 82 is disabled to operate because of no power supply and the backup device 70 is continuously disabled to attain the backup operation by the restriction device 80. Thus vehicle theft can be prevented. The lock unit 81 mechanically restricts the operation of the backup device 70. For instance, if the backup device 70 has a lever or a switch, which can be operated by the vehicle user, the lock unit 81 may restricts the lever from being moved or the switch from being pressed down.

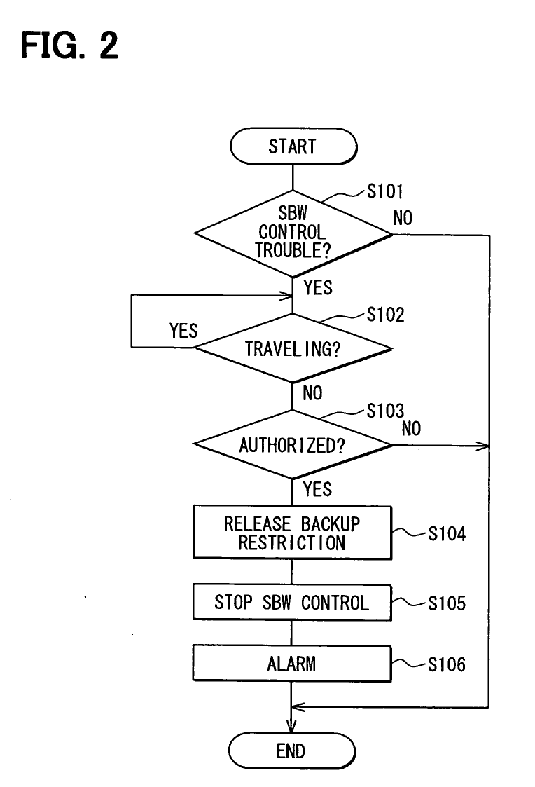

The control operation of the vehicle control system 10 is described next with reference to a flow chart (FIG. 2) executed by the CT-ECU 11. This processing is only a part of entire processing, which the CT-ECU 11 normally executes.

The CT-ECU 11 checks at step S101 whether the SBW device 30 has a trouble such as an abnormality in the shift range control on the automatic transmission apparatus 60. The CT-ECU 11 receives the shift range command of the range selector 14 and the actual shift range of the automatic transmission apparatus 60 from the SBW-ECU 31 and the AT-ECU 21, respectively, and compares the both. The CT-ECU 11 determines NO because of no trouble (shift range control is not impeded) in the SBW device 30, if both agree. The CT-ECU 11 ends this processing so that the SBW-ECU 31 continues its shift range control. The CT-ECU 11 determines YES because of trouble (shift range control in impeded) in the SBW device 30, if both do not agree. The CT-ECU 11 proceeds to step S102.

At step S102, the CT-ECU 11 checks whether the vehicle is traveling (in motion). The CT-ECU 11 receives the speed signal from the vehicle speed sensor 22 to detect the vehicle travel. Other signals such as a G-sensor or GPS position signals of a navigation system may be used in addition to or alternatively to the speed signal.

If the check result at step S102 is YES (traveling), the CT-ECU 11 does not execute following steps, because the backup device 70, if operated, may cause some troubles to the vehicle in motion. If the check result at step S102 is NO (at rest), the CT-ECU 11 checks at step S103 whether a vehicle user is an authorized person by using the immobilizer device 16, which communicates with the key 17 or other identification devices carried by the user. If the check result is NO (unauthorized user), the CT-ECU 11 ends this processing. If the check result is YES (authorized user), the CT-ECU 11 proceeds to step S104.

At step S104, the CT-ECU 11 releases the backup restriction, which is made by the restriction device 80. Specifically, the CT-ECU 11 applies a signal to the driving unit 82, which responsively drives the lock unit 81 with the electric power from the battery 13 to release the backup device 70 from being restricted. Thus, the backup device 70 is enabled to perform its backup operation without restriction by the lock unit 81.

After step S104, preferably after detecting that the backup device 70 is released from restriction, the CT-ECU 11 at step S105 disables the shift range control of the SBW-ECU 31. Thus, the SBW-ECU 31 will not start its shift range control again under the condition that the automatic transmission apparatus 60 is under control by the backup device 70 and the AT-ECU 21. It is to be noted that the automatic transmission apparatus 60 is controlled by the backup operation of the backup device 70 when the SBW device 30 is in failure. If the SBW device 30 becomes normal again and starts to control the automatic transmission apparatus 60 again, its control will interfere with the backup control by the backup device 70. Therefore, it will be preferred not to allow the SBW device 30 to attain its shift range control if the backup device 70 is operated by the vehicle user.

The CT-ECU 11 further drives an alarm device 18 at step S106 to generate an alarm to the user audibly or visually. The alarm device 18, when driven, indicates that the automatic transmission apparatus 60 is operated under control of the backup device 70 and not under control of the SBW device 30.

In this embodiment, when the restriction on the backup device 70 is released, the user is allowed to manually change the shift range of the automatic transmission apparatus 60 through the backup device 70. With the signal from the sensor 15 of the selector 14, the backup device 70 drives the automatic transmission apparatus 60 through the AT-ECU 21. For instance, the shift range of the automatic transmission apparatus 60 may be changed from the parking range P to either the driving range D, reverse range R or neutral range N. Further, the shift range may be changed from the driving range D, reverse range R or neutral range N to the parking range P. The vehicle can be moved to any desired places if the shift range is changed from the parking range P to other ranges such as D, R or N. By changing the shift range to the parking range P by the backup device 70, the vehicle can be parked even on a slope without using the parking brake of the vehicle or any stoppers. Thus, vehicle security can be enhanced.

Further, the backup device 70 cannot be operated unless authorized by the immobilizer device 16 (step S103). That is, only the authorized user is allowed to operate the backup device 70. This will protect the vehicle from theft, even if the vehicle is equipped with the backup device 70, which allows manual operation on the automatic transmission apparatus 60.

### Second Embodiment

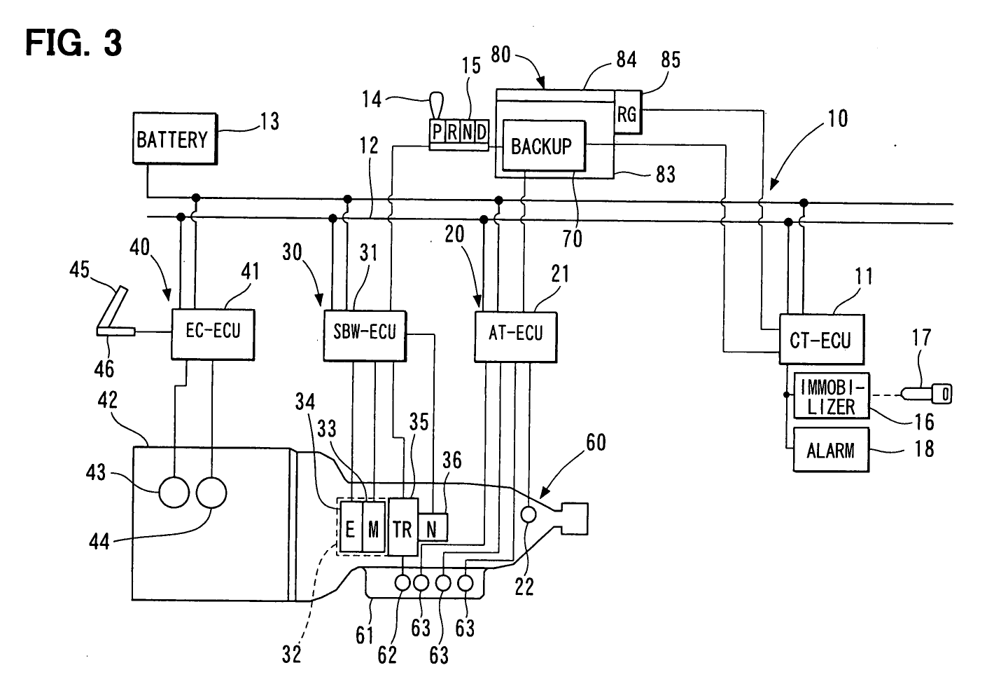

The second embodiment shown in FIG. 3 is similar to the first embodiment except the restriction device 80. Specifically, the restriction device 80 has an accommodation case 83, a top cover 84 and an electronic regulator 85. The accommodation case 83 accommodates the backup device 70 therein. The top cover 84 is for opening and closing the accommodation case 83. The regulator 85 is connected to the CT-ECU 11 to be electronically controlled to open or close the accommodation case 83 in response to a signal from the CT-ECU 11.

The backup device 70 is normally held within the accommodation case 83 and is not manually operable from outside the accommodation case 83, because the top cover 84 normally closes the accommodation case 83. Thus, the backup device 70 is locked within the accommodation case 83 and restricted from being operated. The backup device 70 is operable from outside the accommodation case 83 only when the top cover 84 is driven with the electric power from the battery 13 by the regulator device 85 to allow opening of the accommodation case 83. Thus, the backup device 70 is enabled to attain its backup operation when operated by the user.

The CT-ECU 11 drives the regulator unit 85 with the electric power from the battery 13 to allow the top cover 84 from being moved only when the key 17 (user) is determined as the authorized one. The CT-ECU 11 does not allow the power supply to the regulator 85 when the key 17 is determined as not being authorized. As a result, the regulator unit 85 keeps the top cover 84 locked to the accommodation case 83, thus disabling operation on the backup device 70 from the outside the accommodation case 83.

In the second embodiment, the CT-ECU 11 executes its processing as shown in FIG. 3 in generally the similar manner as in the first embodiment. In this embodiment, however, the CT-ECU 11 releases the operation restriction of the restriction device 80 on the backup device 70 at step S204 after executing steps S101 to S103. With this step, the regulator unit 85 is instructed and supplied with the electric power to release the top cover 84 from being restricted to move. Thus, the top cover 84 is unlocked and is allowed to be opened manually by the user. As a result, the backup device 70 can also be manually operated by the user. After step S204, preferably after detecting that the top cover 84 is actually opened, the CT-ECU 11 executes steps 105 and S106 in the similar manner as in the first embodiment. Thus, the alarm 18 notifies the user of the user's manual operation of the restriction device 80 such as opening of the top cover 84.

According to this embodiment, the authorized user is allowed to open the top cover 84 and operate the backup device 70 manually. As a result, by way of the backup device 70, the shift range of the automatic transmission apparatus 60 may be changed from the parking range P to the other shift ranges or vice versa. Further, since the backup device 70 is normally accommodated within the accommodation case 83 and operable only when the top cover 84 is opened, the backup device 70 will not be operated erroneously by the user while the vehicle is traveling. Thus, safety of the vehicle is enhanced.

### Third Embodiment

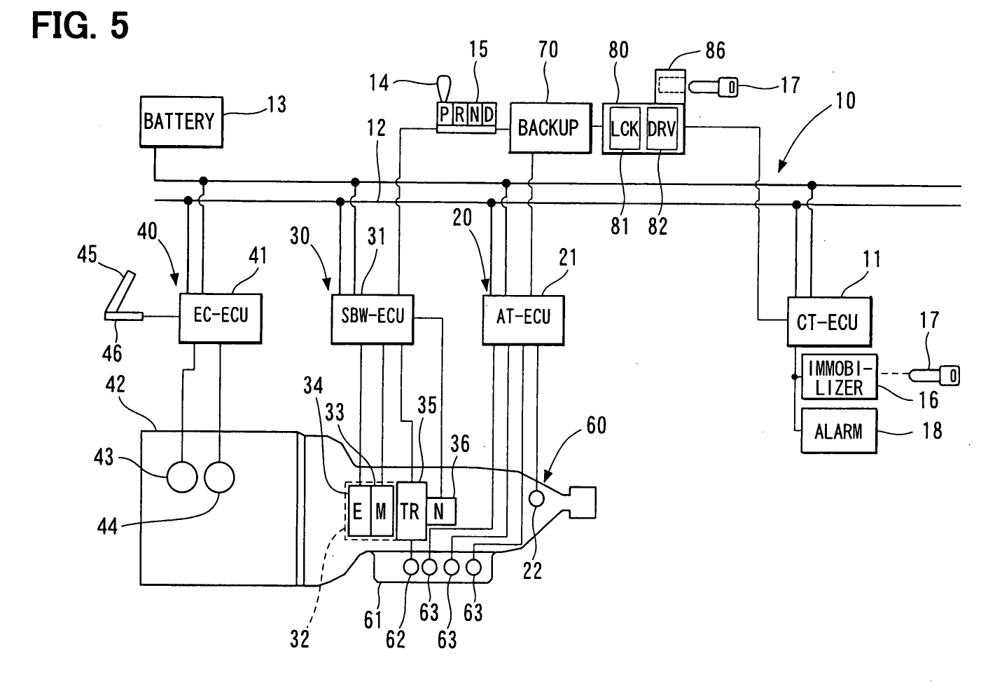

The third embodiment shown in FIG. 5 is similar to the first embodiment except that a key slot unit 86 is provided to the restriction device 80. As long as no power is supplied from the battery 13, the restriction device 80 continues to restrict the backup device 70 from operating. This key slot unit 86 is for releasing, upon insertion of the key 17 into its slot, the backup device 70 from being restricted by the restriction device 80, even when no power is supplied from the battery 13. That is, the key slot unit 86 may be constructed to mechanically release the backup device 70 from the restricted condition.

According to the third embodiment, even when the power supply from the battery 13 is insufficient due to fall of the battery voltage, for instance, the backup device 70 is enabled to operate with the key 17 being inserted into the key slot unit 86.

The third embodiment may be modified such that the key slot unit 86 mechanically allows the top cover 84 of the restriction device 80 of the second embodiment from being unlocked from the accommodation casing 83 in place of the regulator unit 85, which electronically controls the top cover 84.

### Other Embodiments

The restriction device 80 may be constructed with an electric actuator such as an electric motor or an electromagnetic solenoid to be operable with the power supply from the battery 13, or constructed alternatively with a hydraulic actuator operable with hydraulic pressure fluid supplied by a fluid pump driven by the engine 42. The backup device 70 may be released from the restricted condition by a specific ECU, which may be provided within the restriction device 80 to control the restriction or releasing of restriction of the restriction device 80, in place of the CT-ECU 11. Still further changes and modifications may be made to the above embodiments without departing from the spirit of the invention.

What is claimed is:

1. A control system for a vehicle having an engine and a transmission apparatus for transmitting a driving force of the engine, the control system comprising:
a shift-by-wire device that electronically controls a shift range of the transmission apparatus;
a backup device that enables a shift of the shift range to an arbitrary range in the transmission apparatus as a backup operation, when the shift-by-wire device fails to control the shift range of the transmission apparatus;
a restriction device that restricts the backup operation of the backup device, characterized by
a check device that checks whether a vehicle user is an authorized person; and
a restriction control device that releases the backup device from being restricted by the restriction device, when the check device determines that the vehicle user is the authorized person.

2. The control system according to claim 1, further comprising:
a travel detection means that detects a travel of the vehicle,
wherein the restriction control device allows the restriction device to continue to restrict the backup device when the travel detection means detects the travel, even when the check device determines that the vehicle user is the authorized one.

3. The control system according to claim 1,
wherein the restriction device normally restricts the backup operation of the backup device even when no power is supplied thereto from a power source.

4. The control system according to claim 1,
wherein the shift-by-wire device stops to control the shift range when the restriction control device releases the restriction device.

5. The control system according to claim 4, further comprising:
an alarm device notifies audibly or visually that the backup device is released.

6. The control system according to claim 1, further comprising:
a key provided exclusively to each vehicle,
wherein the restriction control device releases the backup device by the key.

7. The control system according to claim 1, wherein the restriction device includes:
a lock unit that mechanically restricts the backup device; and
a driving unit that is controlled by the restriction control device to drive the lock unit.

8. The control system according to claim 1, wherein the restriction device includes:
an accommodation case that accommodates the backup device therein; and
a cover that normally close the accommodation case and is controlled to open by the restriction control device.

9. The control system according to claim 1, wherein the restriction device includes:
a key provided exclusively to each vehicle; and
a key slot unit that releases the backup device, when the key is inserted therein.

10. The control system according to claim 1,
wherein the check device includes an immobilizer device that disables a vehicle operation when the vehicle user is an unauthorized person.

11. A control method for a vehicle having an engine and a transmission apparatus for transmitting a driving force of the engine, the control system comprising:
operating the transmission apparatus electronically by a shift-by-wire device that electronically controls a shift range of the transmission apparatus, while restricting normally by a restriction device a backup device from being operated by a vehicle user to manually control the transmission apparatus;
checking whether the transmission apparatus is operated properly by the shift-by-wire device; and
enabling a manual operation of the transmission apparatus by the backup device, when the transmission apparatus is determined to be not operated properly by the shift-by-wire device, characterized by
checking whether a vehicle user is an authorized person; and
releasing the backup device from being restricted such that the manual operation of the transmission apparatus is enabled, when the vehicle user is determined to be the authorized person.

12. The control method according to claim 11,
wherein the checking is attained by an immobilizer device that is provided to disable a vehicle operation when the vehicle user is an unauthorized person.

13. The control method according to claim 11, further comprising:
checking whether the vehicle is in motion; and
disabling the releasing of the backup device, when the vehicle is determined to be in motion.

14. The control method according to claim 11, further comprising:
disabling the shift-by-wire device to electronically control the transmission apparatus, when the backup device is released to enable the manual operation of the transmission apparatus.

15. The control method according to claim 11, further comprising:
providing an alarm that indicates that the backup device is released.
